(19) United States
(12) Patent Application Publication
(10) Pub. No.: US 2020/0126368 A1
(43) Pub. Date: Apr. 23, 2020

(54) CARD READER AND CONTROL METHOD OF CARD READER

(71) Applicant: NIDEC SANKYO CORPORATION, Nagano (JP)

(72) Inventors: Shigeki OZAWA, Nagano (JP); Keiji MIYAZAWA, Nagano (JP)

(21) Appl. No.: 16/478,262

(22) PCT Filed: Jan. 10, 2018
(86) PCT No.: PCT/JP2018/000339

§ 371 Date: Jul. 16, 2019

(30) Foreign Application Priority Data
Jan. 17, 2017 (JP) 2017-006047

(51) Int. Cl. G07F 19/00; G06K 7/08

(52) U.S. Cl. CPC G07F 19/2055; G06K 7/081

(57) ABSTRACT

A card reader may include a card passage, a magnetic head structured to perform at least one of reading of magnetic data of a card and recording of magnetic data to the card, an electrostatic capacitance sensor structured to detect a foreign matter having been attached to the card passage, a card sensor structured to detect existence or nonexistence of the card in a detection area of the electrostatic capacitance sensor, and a control part which performs foreign matter determination processing in which existence or nonexistence of the foreign matter is determined based on an output signal of the electrostatic capacitance sensor and a predetermined detection threshold value in a case that the control part determines that a card does not exist in the detection area based on an output signal of the card sensor.

### CROSS REFERENCE TO RELATED APPLICATIONS

This is the U.S. national stage of application No. PCT/JP2018/000339, filed on Jan. 10, 2018. Priority under 35 U.S.C. § 119(a) and 35 U.S.C. § 365(b) is claimed from Japanese Application No. 2017-006047, filed Jan. 17, 2017; the disclosures of which are incorporated herein by reference.

### TECHNICAL FIELD

At least an embodiment of the present invention relates to a card reader structured to perform recording and reading of magnetic data to and from a card and relates to its control method.

### BACKGROUND

A fraudulent act (so-called skimming) has become an issue in which, in a card reader structured to take a card recorded with magnetic information inside and to perform recording and reading of magnetic data by a magnetic head, magnetic data are illegally read by attaching a magnetic head to a card insertion part where a card is to be inserted. As a measure for preventing such a fraudulent act, a card reader provided with a sensor for detecting a foreign matter having been attached to the card insertion part has been proposed.

However, a trick of the skimming has become sophisticated year by year, and a situation has occurred that a skimming magnetic head is attached to an inside of a card reader where the skimming magnetic head has not been conventionally attached to read magnetic data illegally. In a case that a skimming magnetic head is attached to an inside of a card reader, a fraudulent act is hard to be noticed because the skimming magnetic head is invisible from the outside. Therefore, it may be occurred that skimming has been performed over a long period and damage becomes large. In order to prevent this problem, a card reader has been proposed which includes a sensor for detecting a skimming magnetic head having been attached to an inside of the card reader. This type of card reader is disclosed in Patent Literature 1.

### CITATION LIST

[PTL 1] Japanese Patent Laid-Open No. 2016-110415

The card reader disclosed in Patent Literature 1 includes an electrostatic capacitance sensor for detecting a foreign matter having been attached to a card passage where a card inserted into an insertion port for a card is passed. When a skimming magnetic head is attached to a card passage, the skimming magnetic head is detected by the electrostatic capacitance sensor as a foreign matter and, as a result, processing is performed, for example, a predetermined alarm is notified to a host apparatus. Therefore, a situation that the skimming magnetic head has been attached can be notified to an administrator and the fraudulent act can be prevented.

However, in a case that a foreign matter having been attached to a card passage is to be detected by an electrostatic capacitance sensor, a card and the foreign matter are hard to be distinguished from each other. Therefore, although the skimming magnetic head is detected as a foreign matter, there is a problem that a card existed in the card passage is erroneously detected as a foreign matter.

### SUMMARY

In view of the problem described above, at least an embodiment of the present invention provides a card reader and its control method capable of detecting a foreign matter having been attached to an inside of the card reader for a fraudulent act by an electrostatic capacitance sensor, and reducing a possibility that a card is erroneously detected as a foreign matter.

To solve the above-mentioned problem, at least an embodiment of the present invention provides a card reader including a card passage where a card inserted into a card insertion port is passed, a magnetic head structured to perform at least one of reading of magnetic data recorded in a magnetic stripe of the card and recording of magnetic data to the magnetic stripe, an electrostatic capacitance sensor structured to detect a foreign matter having been attached to the card passage, a card sensor structured to detect existence or nonexistence of the card in a detection area of the electrostatic capacitance sensor, and a control part which performs foreign matter determination processing in which existence or nonexistence of the foreign matter is determined based on an output signal of the electrostatic capacitance sensor and a predetermined detection threshold value in a case that the control part determines that the card does not exist in the detection area based on an output signal of the card sensor.

To solve the above-mentioned problem, at least an embodiment of the present invention provides a control method of a card reader including a card passage where a card inserted into a card insertion port is passed, a magnetic head structured to perform at least one of reading of magnetic data recorded in a magnetic stripe of the card and recording of magnetic data to the magnetic stripe, an electrostatic capacitance sensor structured to detect a foreign matter having been attached to the card passage, and a card sensor structured to detect existence or nonexistence of the card in a detection area of the electrostatic capacitance sensor. The control method of a card reader includes a card detection step in which existence or nonexistence of the card in the detection area is monitored based on an output signal of the card sensor, and a foreign matter determination step in which existence or nonexistence of the foreign matter is determined based on an output signal of the electrostatic capacitance sensor and a predetermined detection threshold value when determined that the card does not exist in the detection area.

According to at least an embodiment of the present invention, existence or nonexistence of a card in a detection area of the electrostatic capacitance sensor is detected by a card sensor and, when it is determined that the card does not exist, existence or nonexistence of a foreign matter is determined by the electrostatic capacitance sensor. According to this structure, a foreign matter determination is performed when it is clear that a card does not exist and thus, erroneous detection of a card as a foreign matter can be avoided. Therefore, in a case that a skimming magnetic head has been attached to the card passage, the attached skimming magnetic head can be detected with a high degree of accuracy.

In at least an embodiment of the present invention, it is desirable that, when the control part determines that the card exists in the detection area, the control part performs determination of existence or nonexistence of the card in the detection area with a predetermined period until the control part determines that the card does not exist in the detection area based on the output signal of the card sensor. According to this structure, even when a foreign matter determination is unable to be performed due to existence of a card, after the card has been ejected, the foreign matter determination can be performed. Therefore, in a case that a skimming magnetic head has been attached to the card passage, the attached skimming magnetic head can be detected.

In at least an embodiment of the present invention, it is desirable that the card reader includes a temperature sensor, and the control part corrects the detection threshold value based on temperature detected by the temperature sensor and a temperature characteristic of the electrostatic capacitance sensor to perform the foreign matter determination processing based on the corrected detection threshold value. According to this structure, the detection threshold value is not required to set widely in consideration of variation of an output signal of the electrostatic capacitance sensor due to temperature change and thus, the detection threshold value can be set narrowly. Therefore, even in a case that the card reader is installed in a place having large temperature change, a skimming magnetic head attached to the card passage can be detected without deteriorating detection accuracy.

In at least an embodiment of the present invention, it is desirable that the card reader includes a humidity sensor, and the control part corrects the detection threshold value based on humidity detected by the humidity sensor and a humidity characteristic of the electrostatic capacitance sensor to perform the foreign matter determination processing based on the corrected detection threshold value. According to this structure, the detection threshold value is not required to set widely in consideration of variation of an output signal of the electrostatic capacitance sensor due to humidity change and thus, the detection threshold value can be set narrowly. Therefore, even in a case that the card reader is installed in a place having large humidity change, a skimming magnetic head attached to the card passage can be detected without deteriorating detection accuracy.

In at least an embodiment of the present invention, it is desirable that the control part decides determination of the foreign matter existence when a state that a difference between the output signal of the electrostatic capacitance sensor and an electrostatic capacitance reference value is not smaller than the detection threshold value continues over a predetermined amount in the foreign matter determination processing, and the control part performs predetermined abnormality processing. According to this structure, in a case that it is determined due to noise that a foreign matter exists, abnormality processing is not performed.

In at least an embodiment of the present invention, it is desirable that the control part executes the abnormality processing after a predetermined time period or more has elapsed from a time when the determination of foreign matter existence is decided. When abnormality processing is immediately performed after a skimming magnetic head has been attached, existence of a foreign matter detection mechanism and information regarding its operation may be known to a criminal. However, according to this structure, existence of the foreign matter detection mechanism and information regarding its operation can be restrained from being known to a criminal.

According to at least an embodiment of the present invention, existence or nonexistence of a card in a detection area of the electrostatic capacitance sensor is detected by a card sensor and, when it is determined that the card does not exist, existence or nonexistence of a foreign matter is determined by the electrostatic capacitance sensor. Therefore, a foreign matter determination is performed when it is clear that a card does not exist and thus, erroneous detection of a card as a foreign matter can be avoided. Accordingly, in a case that a skimming magnetic head has been attached to the card passage, the attached skimming magnetic head can be detected with a high degree of accuracy.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a plan view showing a card reader in accordance with an embodiment of the present invention and a card.

FIG. 2 is a cross-sectional view showing the card reader in FIG. 1.

FIG. 3 is a plan view showing a detection part of an electrostatic capacitance sensor.

FIG. 4 is a schematic block diagram showing a control system of the card reader.

FIG. 5 is a flow chart showing a foreign matter detection processing.

### DETAILED DESCRIPTION

An embodiment of a card reader and its control method to which at least an embodiment of the present invention is applied will be described below with reference to the accompanying drawings.

### (Card Reader)

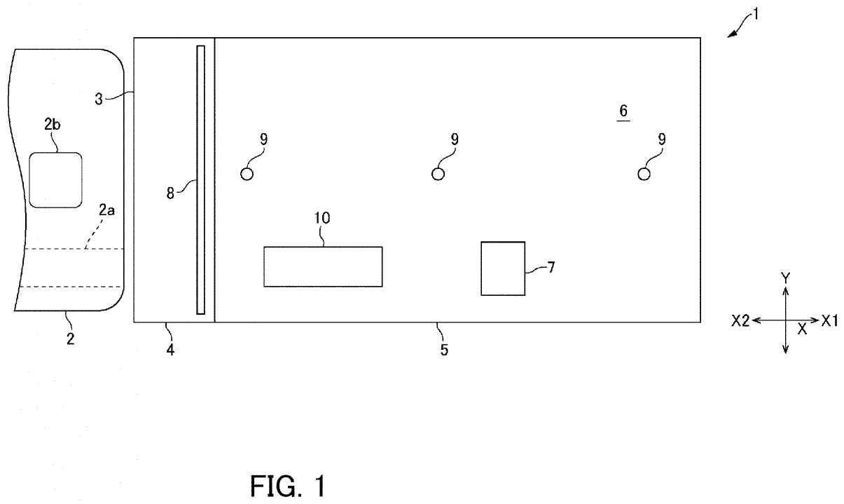

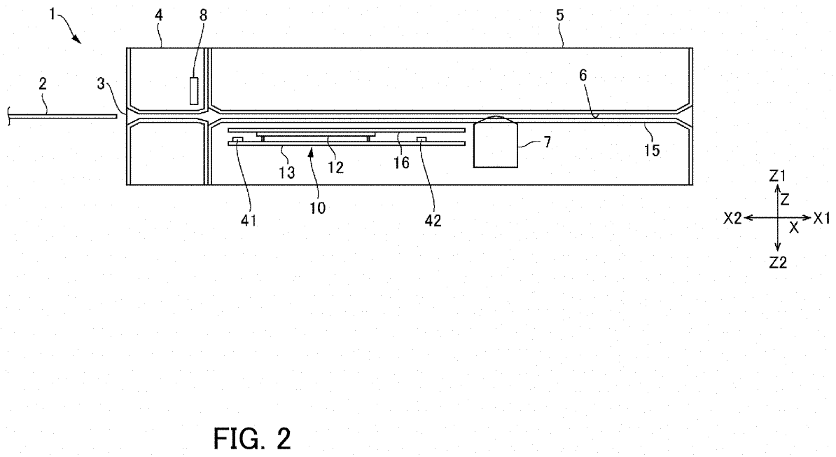

FIG. 1 is a plan view showing a card reader in accordance with an embodiment of the present invention and a card. FIG. 2 is a cross-sectional view showing the card reader and the card in FIG. 1. A card reader 1 is a device structured to perform at least one of reading of magnetic data recorded on a card 2 and recording of magnetic data to the card 2. The card reader 1 is, for example, mounted on a device such as an ATM (Automated Teller Machine).

A card 2 is, for example, a rectangular card made of vinyl chloride whose thickness is about 0.7-0.8 mm. A rear face of the card 2 is formed with a magnetic stripe 2a where magnetic data are recorded. The magnetic stripe 2a is extended in a longitudinal direction of the card 2 having a substantially rectangular shape. Further, an IC chip is incorporated into the card 2, and a front face of the card 2 is formed with an outside connection terminal 2b of the IC chip.

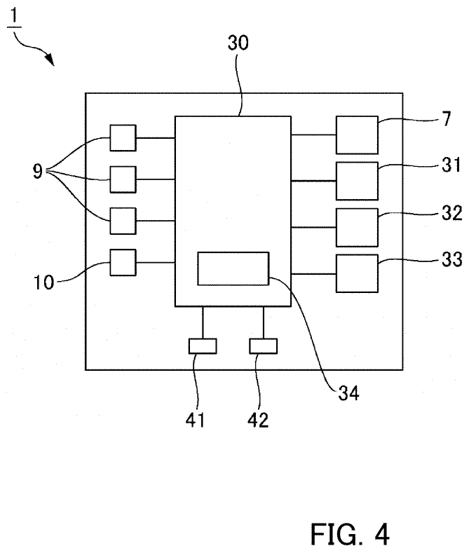

The card reader 1 includes a card insertion part 4 provided with a card insertion port 3 into which a card 2 is inserted and a main body part 5 to which the card insertion part 4 is fixed. The card insertion part 4 is attached to a front end of the main body part 5. An inside of the card reader 1 is formed with a card passage 6 where a card 2 inserted into the card insertion port 3 is passed. Further, the inside of the card reader 1 is disposed with a conveyance mechanism 31 (see FIG. 4) including a drive roller and a pad roller not shown for conveying a card 2 along the card passage 6.

In the present specification, the “X” direction, “Y” direction and “Z” direction are directions perpendicular to each other. Hereinafter, the “X” direction is defined as a front and rear direction, the “Y” direction is defined as a right and left direction, and the “Z” direction is defined as an upper and lower direction. Further, one side (“X1” direction) in the front and rear direction (“X” direction) is defined as a rear side, the other side (“X2” direction) is defined as a front side, one side (“Z1” direction) in the upper and lower direction is defined as an upper side, and the other side (“Z2” direction) is defined as a lower side. As shown in FIG. 2, the card passage 6 is extended in the front and rear direction (“X” direction). The “X1” direction is an inserting direction of a card 2, and the “X2” direction is an ejecting direction of the card 2. A longitudinal direction of the card 2 which is passed along the card passage 6 is coincided with the front and rear direction (“X” direction), a width direction (short width direction) of the card 2 is coincided with the right and left direction (“Y” direction), and a thickness direction of the card 2 is coincided with the upper and lower direction (“Z” direction).

The card reader 1 includes a magnetic head 7 structured to perform at least one of reading of magnetic data recorded in a magnetic stripe 2a and recording of magnetic data to the magnetic stripe 2a, a shutter member 8 for closing the card passage 6, card sensors 9 for detecting existence or nonexistence of the card 2 in the card passage 6, and an electrostatic capacitance sensor 10 for detecting a foreign matter which has been attached to the card passage 6. The card sensor 9 is an optical sensor in this embodiment. However, a sensor which detects existence or nonexistence of a card 2 by a detection method other than an optical type method may be used. Further, the card reader 1 includes an IC contact block (not shown) structured to contact with an outside connection terminal 2b provided in the card 2 to perform communication of data with an IC chip and a block moving mechanism 32 (see FIG. 4) structured to drive the IC contact block.

The shutter member 8 is disposed at a rear end of the card insertion part 4. The shutter member 8 is moved by a shutter drive mechanism 33 (see FIG. 4) between a closing position where the shutter member 8 closes the card passage 6 and an open position where the shutter member 8 is retreated from the card passage 6. The shutter member 8 may be disposed at a boundary portion between the card insertion part 4 and the main body part 5, or at a front end of the main body part 5.

The magnetic head 7 is disposed in the inside of the main body part 5 and is disposed so that a gap part of the magnetic head 7 faces the card passage 6 from a lower side. Further, the magnetic head 7 is disposed at a position in the right and left direction (“Y” direction) where a magnetic stripe 2a of a card 2 inserted into the card insertion port 3 is passed. When a card 2 is passed along the card passage 6, the magnetic stripe 2a is contacted with the gap part of the magnetic head 7 to perform reading of magnetic data or recording of magnetic data.

The card sensor 9 is disposed at a plurality of positions in the inside of the main body part 5. A plurality of the card sensors 9 is disposed with a predetermined space therebetween in the front and rear direction (“X” direction). The card sensor 9 is a transmission type sensor having a light emitting element and a light receiving element which are oppositely disposed so as to interpose the card passage 6. Alternatively, the card sensor 9 may be a reflection type sensor having a light emitting element and a light receiving element which are adjacently disposed to each other on an upper side or on a lower side with respect to the card passage 6. The card sensors 9 are disposed at positions capable of detecting a card 2 which exists in a detection area of a foreign matter by the electrostatic capacitance sensor 10.

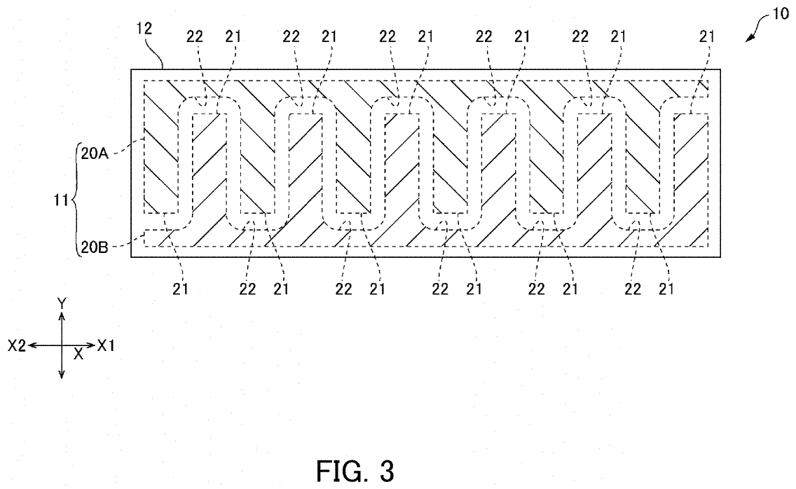

The electrostatic capacitance sensor 10 is disposed in the inside of the main body part 5 and is disposed between the magnetic head 7 and the shutter member 8 in the front and rear direction (“X” direction). The electrostatic capacitance sensor 10 includes an electrostatic capacitance sensor plate 12 in which a thin film-shaped detection part 11 is formed and an electrostatic capacitance detection circuit which is mounted on a control circuit board 13 disposed in parallel to the electrostatic capacitance sensor plate 12. The electrostatic capacitance sensor 10 detects a foreign matter which is disposed in the card passage 6 based on variation of electrostatic capacitance between a pair of electrodes 20A and 20B (see FIG. 3) provided in the detection part 11. Further, a temperature sensor 41 and a humidity sensor 42 are disposed on the control circuit board 13. The temperature sensor 41 is disposed at an end part of the circuit board where influence of heat generated from circuit elements mounted on the control circuit board 13 is small.

FIG. 3 is a plan view showing the detection part 11 of the electrostatic capacitance sensor 10. The detection part 11 includes a detection pattern comprised of the electrodes 20A and 20B and a protection film which covers the detection pattern. The electrodes 20A and 20B are connected with the electrostatic capacitance detection circuit on the control circuit board 13. An output signal of the electrostatic capacitance detection circuit is inputted into a CPU which is mounted on the control circuit board 13, and the CPU generates and outputs a digital signal based on the output signal of the electrostatic capacitance sensor 10. The electrostatic capacitance detection circuit and the CPU may be mounted on a main circuit board not shown which configures the control part 30 of the card reader 1 (see FIG. 4).

As shown in FIG. 3, each of the electrodes 20A and 20B is provided with a plurality of protruded parts 21, which are protruded to one side in the right and left direction (“Y” direction) and disposed with a constant pitch in the front and rear direction (“X” direction), and a plurality of recessed parts 22 formed between the protruded parts 21. In other words, the electrodes 20A and 20B are formed in a comb-teeth shape. A pair of the electrodes 20A and 20B is disposed in a separated state with a predetermined space therebetween in the right and left direction (“Y” direction). Further, in the pair of the electrodes 20A and 20B, the protruded part 21 on one side enters into the recessed part 22 on the other side, and the protruded part 21 on the other side enters into the recessed part 22 on the one side.

As shown in FIG. 2, the electrostatic capacitance sensor 10 is disposed on a lower side with respect to the card passage 6. In this embodiment, a foreign matter escape hole not shown is formed in a guide member 15 which structures a face on a lower side of the card passage 6, and the electrostatic capacitance sensor plate 12 is fixed to a cover 16 made of non-conductive material which is disposed so as to cover the foreign matter escape hole. Alternatively, it may be structured that the electrostatic capacitance sensor plate 12 is directly fixed to the guide member 15. The electrostatic capacitance sensor 10 is disposed so that a thickness direction of the detection part 11 and the upper and lower direction (“Z” direction) are coincided with each other and, in addition, a long side direction of the detection part 11 and the front and rear direction (“X” direction) are coincided with each other. Further, the detection part 11 is disposed at a position in the right and left direction (“Y” direction) where a magnetic stripe 2a of a card 2 inserted into the card insertion port 3 is passed.

FIG. 4 is a schematic block diagram showing a control system of the card reader 1. The card reader 1 includes the control part 30 which controls the magnetic head 7, the conveyance mechanism 31, the block moving mechanism 32, the shutter drive mechanism 33 and the like. The control part 30 controls the shutter drive mechanism 33 and the conveyance mechanism 31 to perform a taking-in operation of a card 2 to the card passage 6 and an eject operation of the card 2. After the card 2 is taken into the card passage 6, the control part 30 controls the magnetic head 7 and the conveyance mechanism 31 to convey the card 2 and to perform recording of magnetic data to the magnetic stripe 2a or reading of magnetic data from the magnetic stripe 2a. Further, the control part 30 drives the block moving mechanism 32 to contact the IC contact block with the outside connection terminal 2b to perform data communication with the IC chip.

Output signals of the card sensors 9 and the electrostatic capacitance sensor 10 are inputted into the control part 30. The control part 30 detects existence or nonexistence of the card 2 at positions of the respective card sensors 9 based on output signals of the plurality of the card sensors 9. When the card 2 is to be conveyed, the control part 30 controls a conveyance position of the card 2 based on the output signals of the plurality of the card sensors 9. Further, the control part 30 detects that a foreign matter has been attached to the card passage 6 based on an output signal of the electrostatic capacitance sensor 10. In addition, output signals of the temperature sensor 41 and the humidity sensor 42 are inputted into the control part 30. As described below, the control part 30 corrects a detection threshold value “CT” which is used in foreign matter detection processing by the electrostatic capacitance sensor 10 based on the temperature and humidity measured by the temperature sensor 41 and the humidity sensor 42.

### (Electrostatic Capacitance Sensor)

An output signal of the electrostatic capacitance sensor 10 in a standby state that a card 2 is not inserted into the card reader 1 is defined as an electrostatic capacitance reference value “CB”. The control part 30 of the card reader 1 includes a storage part 34 which stores the electrostatic capacitance reference value “CB” and a predetermined detection threshold value “CT”. The control part 30 performs the foreign matter detection processing based on an output signal of the electrostatic capacitance sensor 10 and the electrostatic capacitance reference value “CB” and the detection threshold value “CT”. Specifically, when a state that a variation “ΔC” of the output signal of the electrostatic capacitance sensor 10 with respect to the electrostatic capacitance reference value “CB” is not smaller than the detection threshold value “CT” continues a predetermined abnormal determination time “TE” or more, it is determined that a foreign matter exists. The abnormal determination time “TE” is, for example, set in a length such as 30 seconds, 5 minutes or the like. Alternatively, the abnormal determination time “TE” is set in a time period longer than a processing time for processing a normal card 2. According to this structure, when a normal card 2 is processed, the card 2 is not determined as a foreign matter while the card 2 stays in the card passage 6.

When foreign matter detection processing is to be performed by the control part 30 based on an output signal of the electrostatic capacitance sensor 10, the detection threshold value “CT” stored in the control part 30 is corrected based on the current temperature and humidity, and the foreign matter detection processing is performed based on the corrected detection threshold value “CT1”. Temperature correction of the detection threshold value “CT” is performed based on a temperature correction table “TTBL”. The temperature correction table “TTBL” is previously prepared based on a temperature characteristic of the electrostatic capacitance sensor 10 and is stored in the storage part 34. For example, in a case that the electrostatic capacitance has a temperature characteristic which linearly varies in accordance with change in the temperature, the temperature correction table “TTBL” indicating this temperature characteristic is stored in the storage part 34. Similarly, humidity correction of the detection threshold value “CT” is performed based on a humidity correction table “HTBL”. The humidity correction table “HTBL” is previously prepared based on a humidity characteristic of the electrostatic capacitance sensor 10 and is stored in the storage part 34. For example, in a case that the electrostatic capacitance has a humidity characteristic which varies when the humidity exceeds 90%, the humidity correction table “HTBL” indicating this humidity characteristic is stored in the storage part 34.

### (Foreign Matter Detection Processing)

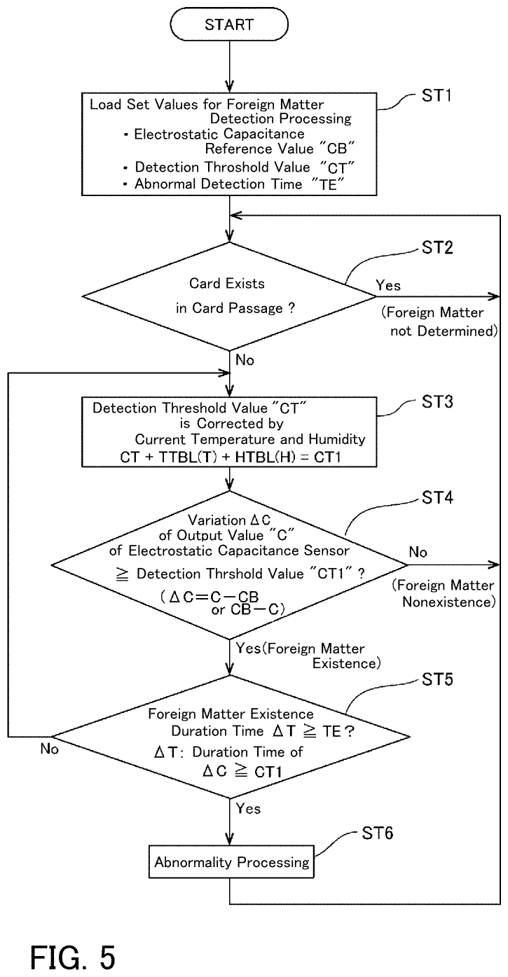

FIG. 5 is a flow chart showing the foreign matter detection processing. The control part 30 of the card reader 1 monitors existence or nonexistence of a card 2 in the card passage 6 based on the output signals of the card sensors 9. When it is determined that a card 2 does not exist in the card passage 6, existence or nonexistence of a foreign matter is determined based on an output signal of the electrostatic capacitance sensor 10 and the corrected detection threshold value “CT1”. In this embodiment, the detection area of the card sensors 9 includes a detection area of the electrostatic capacitance sensor 10 and thus, the card sensors 9 detect existence or nonexistence of a card 2 in the detection area of the electrostatic capacitance sensor 10. In other words, in a case that the control part 30 has determined that a card does not exist in the detection area of the electrostatic capacitance sensor 10, the control part 30 determines existence or nonexistence of a foreign matter based on the output signal of the electrostatic capacitance sensor 10 and the corrected detection threshold value “CT1”.

First, in the step “ST1”, the control part 30 reads out the set values which are used in foreign matter detection processing from the storage part 34. Specifically, the electrostatic capacitance reference value “CB”, the detection threshold value “CT” and the abnormal determination time “TE” are read out from the storage part 34.

Next, the control part 30 performs a card detection step (step “ST2”) in which existence or nonexistence of a card 2 in the card passage 6 is determined based on the output signals of the card sensors 9. When it is determined that a card exists (step “ST2”: “Yes”), processing for determining existence or nonexistence of a foreign matter (step “ST3”) is not performed and, after a predetermined period time (for example, one second) has elapsed, a determination (step “ST2”) of existence or nonexistence of the card 2 is performed again. The determination of the step “ST2” is repeated with the predetermined period time until it is determined that a card 2 does not exist. In other words, monitoring of existence or nonexistence of a card 2 in the card passage 6 is continued with a predetermined monitoring period until it is determined that a card 2 does not exist.

When it is determined that a card does not exist in the step “ST2” (step “ST2”: “No”), the control part 30 performs a foreign matter determination step (steps “ST3” through “ST5”). In the step “ST3”, the detection threshold value “CT” read out from the storage part 34 is corrected with the current temperature and humidity based on the output signals of the temperature sensor 41 and the humidity sensor 42. Specifically, as described above, a correction value “TTBL(T)” is obtained based on an output signal of the temperature sensor 41 and the temperature correction table “TTBL” to perform a temperature correction with respect to the detection threshold value “CT” and, in addition, a correction value “HTBL(H)” is obtained based on an output signal of the humidity sensor 42 and the humidity correction table “HTBL” to perform a humidity correction with respect to the detection threshold value “CT”. As a result, the detection threshold value “CT1” is calculated.

Next, in the step “ST4”, the control part 30 determines whether or not a variation “ΔC” of an output signal of the electrostatic capacitance sensor 10 with respect to the electrostatic capacitance reference value “CB” is not smaller than the corrected detection threshold value “CT1”. The variation “ΔC” is an absolute value and is calculated by: “an output value “C” of the electrostatic capacitance sensor 10”−“electrostatic capacitance reference value “CB””; or by: “the electrostatic capacitance reference value “CB”−“the output value “C””. When the variation “ΔC” is smaller than the detection threshold value “CT1” (step “ST4”: “No”), the processing is returned to the step “ST2” to continue monitoring of existence or nonexistence of a card 2. On the other hand, when the variation “ΔC” is not smaller than the detection threshold value “CT1” (step “ST4”: “Yes”), the processing is advanced to the step “ST5”, and it is determined whether or not a foreign matter existence duration time “ΔT” which is a duration time of a state that the variation “ΔC” is not smaller than the detection threshold value “CT1” is not less than the abnormal determination time “TE”. When the foreign matter existence duration time “ΔT” is not more than the abnormal determination time “TE” (step “ST5”: “No”), the processing is returned to the step “ST3”. Next, the detection threshold value “CT” is corrected with the current temperature and humidity again. In other words, the control part 30 performs determination for an output value “C” of the electrostatic capacitance sensor 10 (step “ST4”) while correcting the detection threshold value “CT” depending on temperature and humidity change at any time and, based on the result, it is determined whether or not the foreign matter existence duration time “ΔT” is not less than the abnormal determination time “TE”. On the other hand, when the foreign matter existence duration time “ΔT” is not less than the abnormal determination time “TE” (step “ST5”: “Yes”), the determination of foreign matter existence is decided.

In a case that the control part 30 has decided the determination of the foreign matter existence in the step “ST5”, it is determined that a foreign matter such as a skimming device has been attached to the card passage 6, and the processing is advanced to an abnormality processing step (step “ST6”). Then, a predetermined abnormality processing is performed in the step “ST6”. As an abnormality processing, for example, processing in which a predetermined alarm notification is transmitted to a host apparatus such as a host computer, processing in which a predetermined indication (error indication, service interrupted indication or the like) is displayed on a display part of the card reader 1, or processing in which a lamp of the card reader 1 is turned on in a predetermined mode is performed. Alternatively, processing may be performed in which the use of the card reader 1 is stopped. For example, processing in which the shutter member 8 is moved to the closing position is performed.

### Principal Effects in this Embodiment

As described above, in the card reader 1 in this embodiment, existence or nonexistence of a card 2 in a detection area of the electrostatic capacitance sensor 10 is detected by the card sensor 9 and, when it is determined that a card 2 does not exist, existence or nonexistence of a foreign matter is determined based on an output signal of the electrostatic capacitance sensor 10. According to this structure, a foreign matter determination is performed when it is clear that a card 2 does not exist and thus, erroneous detection of a card 2 as a foreign matter can be avoided. Therefore, in a case that a skimming magnetic head has been attached to the card passage 6, the skimming magnetic head can be detected with a high degree of accuracy. Accordingly, a fraudulent act caused by a skimming magnetic head having been attached to the card passage 6 can be prevented.

In this embodiment, in a case that a card 2 is detected by the card sensor 9, existence or nonexistence of the card 2 is determined by using the card sensor 9 with a predetermined period until the card 2 is not detected by the card sensor 9 (in other words, until it is determined that a card 2 does not exist in the detection area of the electrostatic capacitance sensor 10). As a result, even when a foreign matter determination is unable to be performed because a card 2 exists in the card passage 6, after the card 2 has been ejected, it is determined that a card 2 does not exist and thus, a foreign matter determination can be performed. Therefore, in a case that a skimming magnetic head has been attached to the card passage 6, the skimming magnetic head can be detected. Accordingly, a fraudulent act can be prevented.

In this embodiment, the detection threshold value “CT” is corrected based on temperature detected by the temperature sensor 41 and the temperature characteristic of the electrostatic capacitance sensor 10 (temperature correction table “TTBL”), and the detection threshold value “CT” is corrected based on humidity detected by the humidity sensor 42 and the humidity characteristic of the electrostatic capacitance sensor 10 (humidity correction table “HTBL”). Further, existence or nonexistence of a foreign matter is determined based on the corrected detection threshold value “CT1” and an output signal of the electrostatic capacitance sensor 10. As a result, the detection threshold value is not required to set widely in consideration of variation of an output signal of the electrostatic capacitance sensor 10 due to temperature change and humidity change and thus, the detection threshold value can be set narrowly. Therefore, even in a case that the card reader 1 is installed in a place having large temperature and humidity change, a skimming magnetic head having been attached to the card passage 6 can be detected without deteriorating detection accuracy. Accordingly, a fraudulent act can be prevented.

In accordance with an embodiment of the present invention, correction of the detection threshold value “CT” by temperature and humidity may be omitted. Further, it may be structured that only the temperature sensor 41 is provided and only temperature correction of the detection threshold value “CT” is performed. Alternatively, it may be structured that only the humidity sensor 42 is provided and only humidity correction of the detection threshold value “CT” is performed.

In this embodiment, in the foreign matter determination processing by using an output signal of the electrostatic capacitance sensor 10, in a case that a state that the variation “ΔC” of the output value “C” of the electrostatic capacitance sensor 10 is not smaller than the detection threshold value “CT1” continues over the abnormal determination time “TE” or more, determination of foreign matter existence is decided to perform a predetermined abnormality processing. Further, while monitoring a duration time of the determination of the foreign matter existence (ΔC CT1), determination of an output value “C” of the electrostatic capacitance sensor 10 is performed (step “ST4”) while correcting the detection threshold value “CT” depending on temperature and humidity change at any time. According to this structure, in a case that it is determined due to noise that a foreign matter exists, abnormality processing is not performed. Further, when the abnormal determination time “TE” is set to be a time longer than a normal processing time for processing a card 2, a card 2 is not determined to be a foreign matter while the card 2 is normally processed. In addition, change of temperature and humidity can be coped with at any time and thus, existence or nonexistence of a foreign matter can be determined with a high degree of accuracy. In accordance with an embodiment of the present invention, determination for deciding determination of a foreign matter can be performed based on a predetermined amount other than the abnormal determination time “TE”. For example, it may be controlled that, in a case that the number of times that it is determined that “ΔC CT1” in the step “ST4” reaches a preset number of times of abnormal determinations or more, determination of foreign matter existence is decided.

In a case that determination of foreign matter existence is decided and predetermined abnormality processing is to be performed, a timing when the abnormality processing is executed may be set after a predetermined time period has elapsed from the decision of the determination of the foreign matter existence. In a case that abnormality processing is immediately performed after a skimming magnetic head has been attached, existence of a foreign matter detection mechanism and information regarding its operation may be known to a criminal. However, according to this structure, existence of a foreign matter detection mechanism and information regarding its operation can be restrained from being known to a criminal. Further, a time period until abnormality processing is executed may be changed each time.

1. A card reader for use with a card having a magnetic stripe, the card reader comprising:
a card insertion part into which the card is inserted;
a card passage where the card inserted into the card insertion port is passed;
a magnetic head structured to perform at least one of reading of magnetic data recorded in the magnetic stripe and recording of magnetic data to the magnetic stripe;
an electrostatic capacitance sensor structured to detect a foreign matter having been attached to the card passage;
a card sensor structured to detect existence or nonexistence of the card in a detection area of the electrostatic capacitance sensor; and
a control part configured to perform foreign matter determination processing, the foreign matter determination processing comprising determining existence or nonexistence of the foreign matter based on an output signal of the electrostatic capacitance sensor and a predetermined detection threshold value in a case that the control part determines that the card does not exist in the detection area based on an output signal of the card sensor.

2. The card reader according to claim 1, wherein when the control part is configured to determine that the card exists in the detection area and perform determination of existence or nonexistence of the card in the detection area with a predetermined period until the control part determines that the card does not exist in the detection area based on the output signal of the card sensor.

3. The card reader according to claim 1, further comprising a temperature sensor,
wherein the control part is configured to detect the predetermined detection threshold value based on temperature detected by the temperature sensor and a temperature characteristic of the electrostatic capacitance sensor to perform the foreign matter determination processing based on a corrected detection threshold value.

4. The card reader according to claim 1, further comprising a humidity sensor,
wherein the control part is configured to correct the predetermined detection threshold value based on humidity detected by the humidity sensor and a humidity characteristic of the electrostatic capacitance sensor to perform the foreign matter determination processing based on a corrected detection threshold value.

5. The card reader according to claim 1, wherein the control part is configured to decide determination of foreign matter existence when a state that a difference between the output signal of the electrostatic capacitance sensor and an electrostatic capacitance reference value is not smaller than the detection threshold value continues over a predetermined amount in the foreign matter determination processing, and the control part performs predetermined abnormality processing.

6. The card reader according to claim 5, wherein the control part is configured to execute the predetermined abnormality processing after a predetermined time period or more has elapsed from a time when the determination of the foreign matter existence is decided.

7. A control method of a card reader, the card reader comprising a card passage where a card inserted into a card insertion port is passed; a magnetic head structured to perform at least one of reading of magnetic data recorded in a magnetic stripe of the card and recording of magnetic data to the magnetic stripe; an electrostatic capacitance sensor structured to detect a foreign matter having been attached to the card passage; and a card sensor structured to detect existence or nonexistence of the card in a detection area of the electrostatic capacitance sensor; the control method of a card reader comprising:
a card detection step comprising monitoring existence or nonexistence of the card in the detection area based on an output signal of the card sensor; and
a foreign matter determination step comprising determining existence or nonexistence of the foreign matter based on an output signal of the electrostatic capacitance sensor and a predetermined detection threshold value when determined that the card does not exist in the detection area.

8. The control method of a card reader according to claim 7, wherein in the card detection step, when determined that the card exists in the detection area, the card detection step is performed with a predetermined period until determined that the card does not exist in the detection area.

9. The control method of a card reader according to claim 7, wherein in the foreign matter determination step, the detection threshold value is corrected based on temperature detected by a temperature sensor provided in the card reader and a temperature characteristic of the electrostatic capacitance sensor, and the existence or nonexistence of the foreign matter is determined based on a corrected detection threshold value.

10. The control method of a card reader according to claim 7, wherein in the foreign matter determination step, the detection threshold value is corrected based on humidity detected by a humidity sensor provided in the card reader and a humidity characteristic of the electrostatic capacitance sensor, and the existence or nonexistence of the foreign matter is determined based on a corrected detection threshold value.

11. The control method of a card reader according to claim 7, wherein
in the foreign matter determination step, determination of foreign matter existence is decided when a state that a difference between the output signal of the electrostatic capacitance sensor and an electrostatic capacitance reference value is not smaller than the detection threshold value continues over a predetermined amount, and
when the determination of the foreign matter existence is decided, an abnormality processing step in which predetermined abnormality processing is executed is performed.

12. The control method of a card reader according to claim 11, wherein in the abnormality processing step, the predetermined abnormality processing is executed after a predetermined time period or more has elapsed from a time when the determination of the foreign matter existence is decided.

13. The card reader according to claim 2, further comprising a temperature sensor,
wherein the control part is configured to correct the predetermined detection threshold value based on temperature detected by the temperature sensor and a temperature characteristic of the electrostatic capacitance sensor to perform the foreign matter determination processing based on a corrected detection threshold value.

14. The card reader according to claim 13, further comprising a humidity sensor,
wherein the control part is configured to correct the predetermined detection threshold value based on humidity detected by the humidity sensor and a humidity characteristic of the electrostatic capacitance sensor to perform the foreign matter determination processing based on a corrected detection threshold value.

15. The card reader according to claim 14, wherein the control part configured to decide determination of foreign matter existence when a state that a difference between the output signal of the electrostatic capacitance sensor and an electrostatic capacitance reference value is not smaller than the detection threshold value continues over a predetermined amount in the foreign matter determination processing, and the control part performs predetermined abnormality processing.

16. The card reader according to claim 15, wherein the control part is configured to execute the predetermined abnormality processing after a predetermined time period or more has elapsed from a time when the determination of the foreign matter existence is decided.

17. The card reader according to claim 2, wherein the control part is configured to decide determination of foreign matter existence when a state that a difference between the output signal of the electrostatic capacitance sensor and an electrostatic capacitance reference value is not smaller than the detection threshold value continues over a predetermined amount in the foreign matter determination processing, and the control part performs predetermined abnormality processing.

18. The card reader according to claim 17, wherein the control part is configured to execute the predetermined abnormality processing after a predetermined time period or more has elapsed from a time when the determination of the foreign matter existence is decided.

19. The control method of a card reader according to claim 8, wherein
in the foreign matter determination step, determination of foreign matter existence is decided when a state that a difference between the output signal of the electrostatic capacitance sensor and an electrostatic capacitance reference value is not smaller than the detection threshold value continues over a predetermined amount, and
when the determination of the foreign matter existence is decided, an abnormality processing step in which predetermined abnormality processing is executed is performed.

20. The control method of a card reader according to claim 19, wherein in the abnormality processing step, the predetermined abnormality processing is executed after a predetermined time period or more has elapsed from a time when the determination of the foreign matter existence is decided.
